(19) United States
(12) Patent Application Publication
(10) Pub. No.: US 2026/0052350 A1
(43) Pub. Date: Feb. 19, 2026

(54) HEARING DEVICE WITH NEURAL NETWORK SPEECH DETECTOR

(71) Applicant: Starkey Laboratories, Inc., Eden Prairie, MN (US)

(72) Inventors: Terence Betlehem, Eden Prairie, MN (US); Parth Mishra, The Colony, TX (US); Daniel Marquardt, Hannover (DE); Xianhua Jiang, Eden Prairie, MN (US); Benjamin Waite, St. Louis Park, MN (US)

(21) Appl. No.: 19/291,176

(22) Filed: Aug. 5, 2025

Related U.S. Application Data
(60) Provisional application No. 63/683,301, filed on Aug. 15, 2024.

(51) Int. Cl. H04R 25/00

(52) U.S. Cl. CPC H04R 25/507; H04R 2225/43

(57) ABSTRACT

An ear-wearable device includes at least one microphone, a receiver that is placed within an ear of a user. An audio processing path of the device receives an audio signal from the at least one microphone and reproduces the audio signal at the receiver. The ear-wearable device includes a deep neural network (DNN) that is coupled to the audio processing path and is trained to distinguish between speech and noise in the audio signal. A speech presence probability (SPP) is determined based on an output of the DNN. The ear-wearable device includes a noise reduction system coupled to the audio processing path and is operable to perform noise reduction on the audio signal. The noise reduction system is coupled to receive the SPP from the DNN and change an aggressiveness of the noise reduction based on a value of the SPP.

### RELATED PATENT DOCUMENTS

This application claims the benefit of U.S. Provisional Application No. 63/683,301 filed on Aug. 15, 2024, which is incorporated herein by reference in its entirety.

### SUMMARY

This application relates generally to ear-level electronic systems and devices, including hearing aids, personal amplification devices, and hearables. In one embodiment, an ear-wearable device includes at least one microphone, a receiver that is placed within an ear of a user. An audio processing path of the device receives an audio signal from the at least one microphone and reproduces the audio signal at the receiver. The ear-wearable device includes a deep neural network (DNN) that is coupled to the audio processing path and is trained to distinguish between speech and noise in the audio signal. A speech presence probability (SPP) is determined based on an output of the DNN. The ear-wearable device includes a noise reduction system coupled to the audio processing path and is operable to perform noise reduction on the audio signal. The noise reduction system is coupled to receive the SPP from the DNN and change an aggressiveness of the noise reduction based on a value of the SPP.

The figures and the detailed description below more particularly exemplify illustrative embodiments.

### BRIEF DESCRIPTION OF THE DRAWINGS

The discussion below makes reference to the following figures.

FIG. 1 is an illustration of ear-wearable devices according to an example embodiment;

FIG. 2 is a block diagram showing a sound processing system according to an example embodiment;

FIGS. 3 and 4 are a block diagrams showing neural network arrangements according to example embodiments;

FIG. 5 is a block diagram showing training of a neural network according to an example embodiment;

FIG. 6 is a block diagram of a recurrent neural network according to an example embodiment;

FIG. 7 is a flowchart of a method according to an example embodiment; and

FIG. 8 is a block diagram of a hearing device and system according to an example embodiment.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

Embodiments disclosed herein are directed to an ear-worn or ear-level electronic hearing device. Such a device may include cochlear implants and bone conduction devices, without departing from the scope of this disclosure. The devices depicted in the figures are intended to demonstrate the subject matter, but not in a limited, exhaustive, or exclusive sense. Ear-worn electronic devices (also referred to herein as “hearing aids,” “hearing devices,” “ear-wearable devices,” and “audio wearables”), such as hearables (e.g., wearable earphones, ear monitors, and earbuds), hearing aids, hearing instruments, and hearing assistance devices, typically include an enclosure, such as a housing or shell, within which internal components are mounted or disposed.

Embodiments described herein relate to audio enhancement features in an ear-wearable device, such as noise reduction and speech enhancement. The current situation in which this invention is intended for use involves the widespread use of audio wearable (AW) devices, such as earbuds, hearing aids, and other wearable audio devices, in various environments. These devices are commonly used by individuals seeking to listen to music, communicate, or enhance their hearing abilities.

One of the significant challenges faced by users of these devices is the presence of unwanted background noise, especially in non-stationary or dynamic environments. Examples of such environments include crowded streets, public transportation, or busy workplaces. In these settings, traditional noise reduction techniques often struggle to effectively suppress the noise, leading to diminished audio quality and user frustration.

Additionally, AW devices are often constrained by limited resources such as power and processing capabilities, particularly in smaller devices like hearing aids and earbuds. This limitation further complicates the task of implementing effective noise reduction algorithms while maintaining device performance and battery life.

Overall, the current situation suggests the need for more refined solutions to enhance noise reduction capabilities in AW devices, particularly in dynamic and noisy environments, while addressing resource constraints to ensure practicality and usability. The methods and apparatuses described herein aim to address these challenges by integrating machine learning models such as deep neural networks (DNN) into in-ear device's hardware, offering continuous and real-time noise reduction without compromising performance.

As described below, one or more AW devices are equipped with a sound enhancement utility that utilizes one or more Deep Neural Networks (DNN). The DNN are capable of operating in real-time and may always be active, e.g., integrated into embedded Digital Signal Processing (DSP) hardware. This approach can improve noise reduction, ultimately resulting in improved audio quality and enhanced user experience. Unlike some noise reduction techniques, DNNs exhibit adaptable and dynamic noise reduction capabilities, enabling them to effectively address the complex challenges presented by changing and unpredictable noise environments.

The merits of incorporating DNN for noise reduction in AW devices include improving audio quality by efficiently suppressing unwanted noise. DNNs also exhibit real-time adaptability, allowing them to swiftly adjust to changing noise conditions, enabling optimal noise reduction performance in dynamic environments. Furthermore, the ability to train DNN models to match the specific characteristics of individual in-ear devices offers a high degree of customization. This customization enables the creation of noise reduction solutions that can be individually tailored to the application and use case.

In small devices like hearing aids and earbuds, where power and resources are limited, integrating large-scale neural networks for noise reduction can be challenging due to their resource-intensive nature. To address this, one practical strategy is to use scaled-down versions of neural networks. While this conserves resources, it often results in reduced performance. Alternatively, selectively replacing specific subsystems of processing blocks with smaller neural networks offers another solution. This method maintains the device's core structure while still leveraging the benefits of neural network technology, enhancing noise reduction capabilities within operational constraints. It strikes a balance between innovation and practicality, offering a cost-effective means to improve noise reduction in in-ear devices without compromising overall performance.

The embodiments describe below tackles several significant challenges encountered by AW users, particularly in environments with competing speakers and background noise. The classical approach is to apply signal processing to reduce the noise level whilst preserving the speech signal. This enhances a user's ability to listen to the target speaker. Embodiments described herein seek to provide an improved level of noise reduction (NR) for speech enhancement for AWs by using a neural network.

Conventional NR algorithms reduce the noise in AWs but these algorithms also risk introducing artifacts such as speech suppression, speech distortion and musical noise. Due to the risk of introducing artifacts, it is often best to use these algorithms in a somewhat conservative manner. By turning down the strength of the algorithm when speech is active, perceptible artifacts in the speech can be removed. The severity of the artifacts and hence the management strategy required to mitigate these artifacts can depend upon the noise environment.

One way to limit speech artifacts produced by the NR algorithm is to use a processing block which implements a strength management strategy (SMS). This strategy effectively governs the intensity of the NR algorithm's actions. The SMS performs the function of limiting the instances and scenarios in which the NR algorithm is active. The SMS turns down the NR algorithm in quiet environments to preserve the speech when no NR is required. The SMS turns up the NR algorithm in high-noise environments when speech is significantly degraded by competing noise. Here, artifacts may be produced, but if the SMS is appropriately tuned, these artifacts are at levels acceptable to the user. The SMS may impose a limit on the maximum level of NR.

To achieve its function, the SMS estimates how much speech is in the incoming signals. The SMS may be driven by speech-presence-related metrics such as signal-to-noise ratio, speech presence probability (SPP), a binary voice-activity flag, and/or the signal level. The SMS may also be guided by the sound levels at certain frequencies, since certain sound levels are typical of speech conversation.

A concern arises from the quality of the input metric(s) provided to the SMS. The input metric plays a role in guiding the actions of the SMS. If the information provided to the SMS is of poor quality, it can severely impair the performance of the NR algorithm. The function of the input metric to help correctly distinguishing speech from competing noises. Some competing noise types are harder to distinguish from speech than others. Classical techniques are good at identifying stationary noise types such as airplane noise. Non-stationary noise types such as babble noise and dinner cutlery are harder to identify using classical techniques and may be better identified using DNNs.

Specifically, inferring input metrics such as SPP from lower-quality metrics such as modulation-based features can be challenging. Modulation-based features often struggle to distinguish speech from non-stationary noise types. They may require substantial smoothing to improve their reliability. Improving the quality of SPP estimates can empower the NR algorithm to act decisively, mitigating the risk of introducing audible artifacts.

We note that the modulation-based features primarily distinguish between stationary and non-stationary signals, rather than precisely identifying speech presence. During the DNN training stage, parameters are set to differentiate speech from noise, encompassing not only stationary but also non-stationary noise events. These distinctions provide accurate classification, ensuring the system's responses align with speech presence rather than signal variability alone.

One goal of DNN-assisted NR is to feed higher quality, DNN-based information into the signal processing components (namely, the SMS and NR algorithm) to improve the performance and robustness of the algorithm. This approach seeks to address the challenge of balancing aggressiveness in noise reduction with the prevention of undesirable artifacts, ultimately enhancing the performance and user experience of AW devices in diverse acoustic environments.

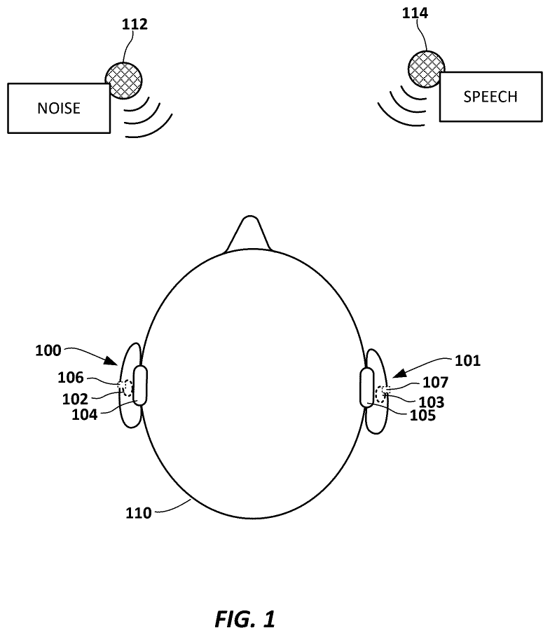

In FIG. 1, a diagram illustrates an example of ear-wearable devices 100, 101 according to an example embodiment, also referred to below as hearing devices. Both left and right ear-wearable devices 100, 101 are shown, each include a respective in-ear portion 102, 103 that fits into the ear canal of a user/wearer 110. The ear-wearable devices 100, 101 may also include respective external portions 104, 105, e.g., worn over the back of the outer ear. The external portions 104, 105, if provided, are electrically and/or acoustically coupled to the internal portions 102, 103.

One or both of the in-ear portions 102, 103 and external portions 104, 105 may include an acoustic transducer, referred to herein as a “receiver,” “loudspeaker,” etc., although could include a bone conduction transducer. If the acoustic transducer is located on the external portions 104, 105, it may be acoustically coupled to the user's ear via a tube and earpiece.

One or both of the in-ear portions 102, 103 and external portions 104, 105 may include an external microphone, as indicated by respective microphones 106, 107. The external portions 104, 105, if included, may each have two microphones, e.g., front and rear microphones (not shown). Generally, an external microphone is situated to pick up sounds originating away from the user 110, as opposed to an internal microphone that is configured to pick up sounds within the ear canal.

Other components of hearing devices 100, 101 not shown in the figure may include a processor (e.g., a digital signal processor or DSP), memory circuitry, power management and charging circuitry, one or more communication devices (e.g., one or more radios, a near-field magnetic induction (NFMI) device), one or more antennas, buttons and/or switches, for example. The hearing devices 100, 101 can incorporate a long-range communication device, such as a Bluetooth® transceiver or other type of radio frequency (RF) transceiver, which can be used to communicate with each other and with external devices as described below.

While FIG. 1 shows one example of a hearing device, the term hearing device of the present disclosure may refer to a wide variety of ear-level electronic devices that can aid a person with or without impaired hearing. This includes devices that can produce processed sound for persons with normal hearing, such as noise addition/cancellation to treat misophonia, or wireless earbuds for electronic sound playback. Hearing devices include, but are not limited to, behind-the-ear (BTE), in-the-ear (ITE), in-the-canal (ITC), invisible-in-canal (IIC), receiver-in-canal (RIC), receiver-in-the-ear (RITE) or completely-in-the-canal (CIC) type hearing devices or some combination of the above. Throughout this disclosure, reference is made to a “hearing device” or “ear-wearable device,” which is understood to refer to a system comprising a single left ear device, a single right ear device, or a combination of a left ear device and a right ear device.

As seen in FIG. 1, the user 110 may be in an environment with multiple sources of sound, here simplified to two sources, noise 112 and speech 114. The sounds may emanate from more than just single locations. For example, in an environment such as a moving vehicle, noise may generally surround the user instead of appearing to originate from a single pint. Nonetheless, the ear-wearable devices 100, 101 may classify a current audio stream as one of these two categories, and make noise reduction changes based on that classification. There may be other categories besides speech and noise, such as music, electronic sounds/alerts, etc., that may be treated differently from noise 112. Typically, the user 110 will prioritize speech 114 over other categories, and so the embodiments below may prioritize speech clarity over other objectives.

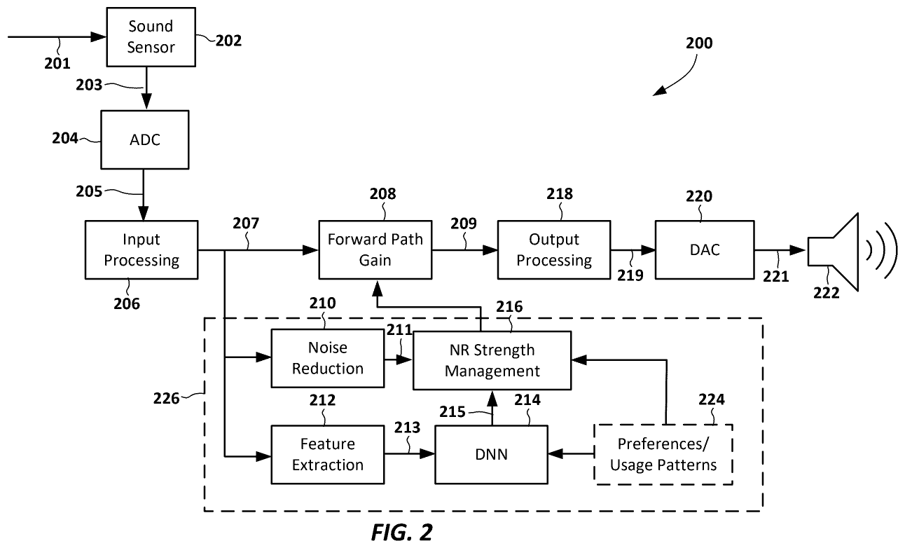

The ear-wearable devices 100, 101 employ DNN technology to enhance noise reduction. The DNNs and associated processing modules improve speech perception, audio quality, and user satisfaction. This approach can improve noise reduction performance in challenging acoustic settings. Such devices are suitable for users who rely on clear audio quality in noisy and ever-changing environments. The ear-wearable devices 100, 101 may use a signal processing system 200 for regulating the noise reduction strength as shown in FIG. 2.

The signal processing system 200 detects incoming sound 201 at a sound sensor 202, e.g., a microphone. The signal processing system 200 can be designed to accommodate both single-microphone and multi-microphone configurations. An analog signal 203 from the sound sensor 202 is input to an analog-to-digital converter (ADC) 204, which converts the analog signal to a digital bit stream 207 via input processing block 206. The input processing block 206 may, for example, perform conditioning on the digital signal 205 from the ADC 204, such as filtering, assembling into processing blocks/frames for fast Fourier transform (FFT) or weighted overlap add (WOLA) processing, etc.

The digital bit stream 207 is distributed between a forward path gain block 208, a noise reduction system 226. The forward path gain block 208 applies selective gain and/or attenuation the bit stream 207 to emphasize or deemphasize certain aspects of the sound. The output bit stream 209 from the forward gain block 208 is further processed by an output processor 218, which may, for example, apply equalization to compensate for a hearing condition. The final digital stream 219 is input to a digital-to-analog converter (DAC) 220, which provides an analog signal 221 used to drive a receiver 222.

The noise reduction system 226 is shown encompassing other components such as a noise reduction bock 210, feature extraction block 212, DNN 214 and SMS block 216. This is meant for illustration and not of limitation, and some of the components such as the feature extraction block 212 and DNN 214 may be part of other modules and/or have other functions and may be used for purposes besides noise reduction. For example, SPP metrics may be used by other processing subsystems such as directionality, which attempts to emphasize or deemphasize sound based on a direction from which the sound originates.

The noise reduction block 210 provides an estimate of noise in the digital bit stream 207 and provides a signal mask 211 which can be combined with the digital bit stream 207 in the forward path gain block 208 in order to reduce noise. The signal mask 211 is first processed/tuned by a SMS block 216 in order to adjust strength of the NR applied to the sound. As described below, a DNN 214 makes a determination of speech presence that can be used to adjust NR.

The feature extraction block 212 extracts features 213 which are mapped onto an input layer of the DNN 214. An SPP output 215 output is used estimate speech probability in the digital bit stream 207. The SPP output 215 may be provided directly by the DNN 214, or may be derived based on some other metric that the DNN 214 was trained to provide. The SPP output 215 informs the SMS about the presence or likelihood of speech, enhancing its intelligence. The DNN-informed SPP data is incorporated into the SMS processing block 216, thereby enhancing its capability to distinguish speech from background noise, facilitating a more precise and adaptive noise reduction strategy.

The DNN-informed information in the SPP output 215 is effective in detecting non-stationary noises, allowing a more aggressive noise reduction approach. The SPP output 215 may be a figure of merit ranging between 0 and 1. In such an embodiment, an SPP value of 1 indicates a high probability of speech and 0 indicates a low probability. The DNN 214 may be trained to provide similar outputs that estimate other targeted types of sounds, such as music, machine sounds (e.g., phone ringing), animal sounds, etc.

As indicated by block 224, the DNN 214 and/or SMS block 216 may be configurable based on any combination of (e.g., one or both) individual hearing preferences or usage patterns. For example, the user may disable SPP estimation, or select a maximum amount that it can affect NR. In other embodiments, DNN weights and/or SMS settings may be changed based on current conditions, e.g., high/low noise environments, whether the user is using the device for a non-speech purpose such as listening to music, sleep detection, etc.

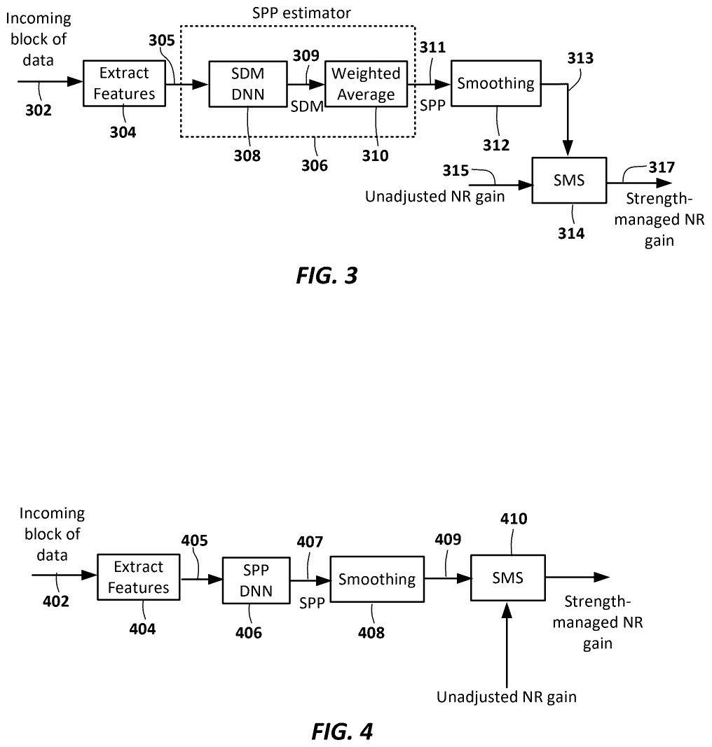

In FIG. 3, a block diagram shows configuration of a DNN according to an example embodiment. An incoming bit stream 302 of data has features 305 extracted by a feature extraction block 304 that is used by an SPP estimator 306, which includes a DNN 308. The features 305 are input to the DNN 308, which is trained to provide a signal-to-noise ratio (SNR) driven mask (SDM) 309. Generally, the SDM 309 provides a frequency variable gain value based on signal to noise ratio (SNR) that is be applied to the noisy speech signal.

The SDM 309 is processed via a weighted average block 310 that weights and averages the SDM 309 with perceptual weights, such as those associated with the Speech Intelligibility Weighting Function. A mask may be considered a weighting applied to the input noisy-speech signal in order to separate the speech from the noise. Typically, the speech is in some frequency bands and noise in other frequency bands. A mask can be applied to a signal to emphasize frequency bands where speech is dominant and to deemphasize frequency bands where noise is dominant. More generally, the SDM weighting can be time-varying. One could apply a time-frequency weighting to boost the time-frequency blocks where speech is dominant and attenuate time-frequency blocks where speech is not present. This is called a time-frequency mask.

The weighted average block 310 provides a rough SPP signal 311, which may vary significantly over small time scales. A smoothing block 312 applies smoothing or averaging so that the system responds to changes in speech activity over an appropriate timescale. The smoothing block 312 outputs a smoothed SPP 313 to an SMS block 314 as previously described. Note that the smoothed SPP 313 may be in the form of a probability, e.g., a value between 0 and 1, or in the form of the SDM. The SMS block 314 may be able to use the SDM directly and/or the SDM may be converted to an SPP via any of the processing blocks 306, 312, 314. Even if used directly by the SMS block 314, the SDM may provide an indication of an amount of speech presence, e.g., if the mask indicates low SNR over a majority of frequency buckets, this may be indicative of a low probability of speech.

The SMS block 314 determines (e.g., reads, receives) a current value of unadjusted NR gain 315 (e.g., gain determined using current settings) and, based on the smoothed SPP 313, provides strength-managed NR gain 317. Generally an aggressiveness of the NR (e.g., maximum/minimum attenuation, NR algorithm and/or algorithm parameters) is adjusted based on the value of the strength-managed NR gain 317. Here and elsewhere, the term “gain” is used generally with regards to NR, and may apply to any type of change to any aspect of the NR, such as aggressiveness, strength, speed, complexity, assertiveness, and/or perceptibility of the NR processing.

In FIG. 4, a block diagram shows a DNN according to another example embodiment. An incoming bit stream 402 of data has features 405 extracted by a feature extraction block 404 that is used by a DNN 406, which is trained to directly estimate the SPP 407. A smoothing block 408 provides a smoothed SPP 409 to an SMS block 410 as previously described.

Note that a DNN may be used that provides both SDM and SPP outputs. The DNN may be trained to jointly estimate/predict both outputs (as well as possibly other outputs) that are used with different processing blocks within the signal processor. In other embodiments, the DNN may be trained to estimate SDM and employ alternate output layers that convert SDM to SPP. These output layers may also be trained or use an explicitly defined encoding/transformation scheme.

In Table 1 below, additional details are provided regarding configuration of the DNN described herein according to one example embodiment. The configuration shown in Table 1 was implemented on a prototype to test the model's real time performance. A DNN with similar characteristics can be implemented in other ways as described elsewhere herein and the illustrated example is not meant to be limiting.

TABLE 1

| Deep Neural Network | |
|---|---|
| Parameter | Value |
| Network Topology and use | Input −> LSTM−> LSTM −> Dense |
| of recurrent units | Layer−> Output |
| | (GRU can also be used instead of LSTM) |
| Data format for inputs | Features are extracted from the digitized |
| | microphone signal. These features may be |
| | extracted directly from the time-domain data |
| | or the microphone signal can be converted to |
| | the frequency domain using techniques such |
| | as the Fast Fourier Transform (FFT). |
| Activation Function | Sigmoid Activation Function |
| Learning Paradigm | Supervised Learning to minimize error |
| | between ground truth and the predicted SDM |
| Training Dataset | Multiple hours of noisy speech signals with |
| | varying signal-to-noise ratios and noise types |
| | (80% train, 10% validation, 10% test) |
| Cost Function | Mean Squared Error Loss |
| Starting Values | Random Values |

The DNN adopts a dynamic approach to adjust NR gains in real-time, ensuring they are finely tuned to the prevailing acoustic conditions, thereby optimizing the user experience. This can provide improved performance compared to relying on modulation-based features, which may prove overly conservative. One advantage of this embodiment is that SPP may be efficiently estimated with a smaller-sized neural network than is possible with a traditional speech-enhancement DNN.

The feature extraction process described above (e.g., blocks 308 and 404 in FIGS. 3 and 4) is not limited to frequency domain (FD) features (e.g., magnitude and phase). The processing may extract a wider range of features, including those learned from multichannel time-domain (TD) signals and/or multichannel FD representations. These extracted features may be spectrograms, inter-channel time differences, inter-channel level differences and/or signal correlations. This versatility allows for flexible signal processing techniques tailored to the specific requirements of the application.

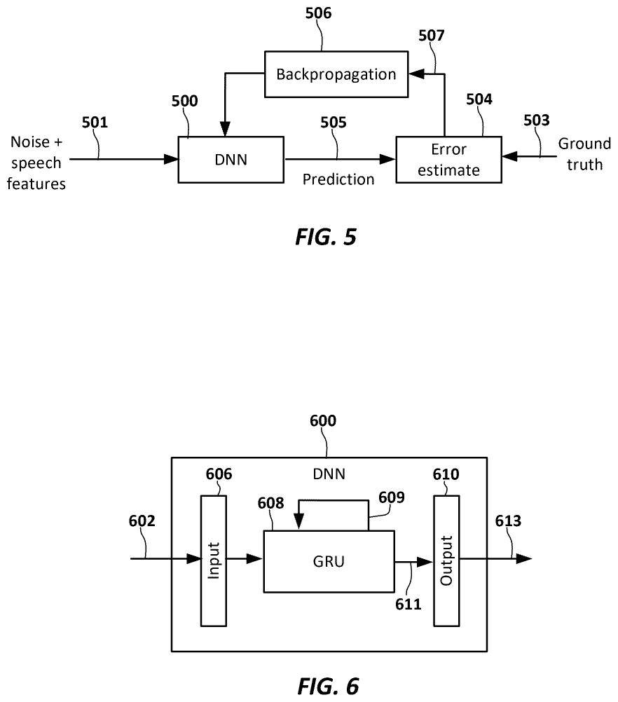

In the embodiments described above, the neural network is trained to estimate the SPP and/or SDM as previously described. In FIG. 5, a block diagram illustrates supervised training of a neural network 500 according to various embodiments. A training data set is prepared for the training, which in this example includes an input signal 501 and corresponding ground truth data 503 that provides a desired output of the neural network. The input signal 501 includes speech-plus-noise features that may be time domain or frequency domain. The training data may be based on simulated sound, e.g., combinations of different low-noise speech audio combined with various levels and types of noise. The training data may instead be real-world recordings of speech and noise that are labeled with desired values of SPP and/or SDM. The ground truth data 503 may be the “correct” values of SPP and/or SDM expected from the neural network 500, or may be a set of features, e.g., features of the pure speech components of the speech-plus-noise used as input to the network 500.

The neural network 500 makes predictions 505 of the SPP and/or SDM, and those predictions are compared to the ground truth data 503 via an error estimator 504, which provides a measure of error 507. The error 507 may be calculated using a loss function such as minimum mean-squared error (MMSE). The error 507 is used to adjust weights and biases of the neural network 500 via a backpropagation function 506 to minimize a difference between the prediction 505 and ground truth data 503. This process is performed iteratively until the error 507 falls below a threshold, and can be validated against another set of training data, often referred to as validation data.

Note that there are other ways of training the neural network 500 besides supervised learning. For example, in unsupervised learning, the neural network 500 (or other algorithm such as a clustering algorithm) may be used to categorize the speech-plus-noise features 501 into various patterns, groups or clusters. These self-taught groupings may be usable to derive the desired outputs of SPP and/or SDM. The SDM serves as a signal-to-noise ratio driven mask, bounded between 0 and 1.

The neural networks described herein may have different structures and algorithms depending on such factors as the desired outputs, the available inputs (e.g., single or multiple microphones), desired computational complexity, etc. The input signal can be configured as one or both of frequency domain or time domain data streams. For frequency domain, the signal can be expressed as Y(k, l)=X(k, l)+V(k, l), where Y(k, l) is the noisy signal, X(k, l) is the desired speech component, V(k, l) is the undesired noise component, k is the frequency index, and/is the block index. These spectral coefficients serve as the input to the DNN. The signal in time domain can be expressed as: y(n)=x(n)+v(n), where y(n) is the noisy signal, x(n) is the desired speech component, v(n) is the undesired noise component, and n is the sample index.

In FIG. 6, a block diagram shows structure of a DNN 600 according to an example embodiment. The DNN 600 comprises several layers designed to process an input signal 602 and predict the target quantity. The input signal 602 includes time domain and/or frequency domain features of the audio stream, and may be pre-computed by another module, e.g., feature extraction module 212 in FIG. 2. The output signal (prediction 613) may include at least one of SPP or SDM as described above.

The input signal 602 is received by an input layer 606, which accepts data of a certain format, e.g., vector of features, frame of time domain audio data, etc. The input signal 602 will include any combination of speech and noise components. The input layer 606 is coupled to a recurrent unit 608, which is processing unit associated with recurrent neural networks (RNN). Recurrent units capture temporal dependencies within the input signal, aiding in extracting target features for speech enhancement. This is indicated by arrow 609, which generally indicates retaining history of input data 602. The illustrated recurrent unit 608 is a gated recurrent unit (GRU), although other recurrent units may be used such as long short-term memory (LSTM). The recurrent unit 608 may use a large sequence (e.g., more than 2) of adjacently connected layers, therefore be considered a deep network.

The DNN 600 includes an output layer 610 that is coupled to the recurrent unit 608. The recurrent unit 608 provides a prediction 611 that is mapped to the output layer 610. The output layer 610 provides a prediction 613 with the meaning and format for which it was trained, e.g., presented as a number indicative of the prediction of SPP and/or SDM. There may other layers between the input layer 606, recurrent unit 608 and output layer 610, e.g., feedforward layers, and these other layers may also be considered deep networks on their own. The weights and biases of NN connections between the input layer 606 and the output layer 610 of the trained DNN 600 represent an operational configuration of the DNN 600. The operational configuration is transferred from a training machine to an operational hearing device e.g., via firmware or software installation or update, where it runs on one or more local processors.

The DNN architecture is designed to learn the complex relationships between input features and the corresponding SPP/SDM values, facilitating accurate prediction and effective speech enhancement. Other types of DNNs may be used instead of or in combination with the illustrated RNN. Other machine learning models that may be embodied as DNNs include transformer networks, convolutional neural networks (CNNs), and encoder-decoder structures. A transformer network is also useful for temporally changing data, as it can be used to predict a state or outcome of sequence-to-sequence tasks while handling long-range dependencies. An encoder-decoder neural network uses an encoder to convert an input to a latent space representation, which can then be decoded to reconstruct the latent space representation into an analogous form. A CNN applies convolutions using a filter/kernel over a time varying signal, which can identify temporal patterns in a signal. The DNN may include a combination of different types of deep learning models (e.g., CNN and RNN).

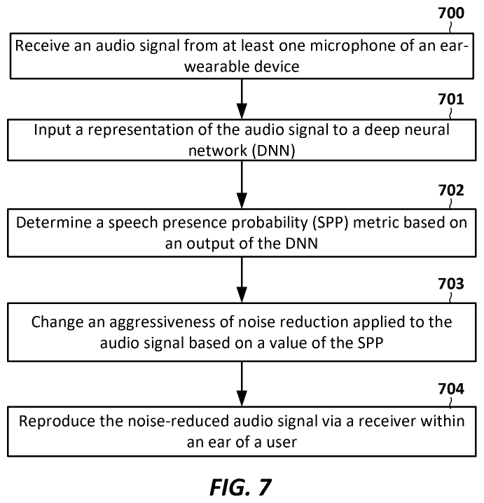

In FIG. 7, a flowchart illustrates a method according to an example embodiment that may be processor-implemented in an ear-wearable device. The method involves receiving 700 an audio signal from at least one microphone of the ear-wearable device. The audio signal is input 701 to a deep neural network (DNN) that is trained to distinguish between speech and noise in the audio signal. A speech presence probability (SPP) metric is determined 702 based on the output of the DNN. The output of the DNN may include the SPP and/or a SDM, and SPP may be determined indirectly from the SDM. An aggressiveness of noise reduction applied to the audio signal is changed 703 based on a value of the SPP. The noise-reduced audio signal is reproduced 704 via a receiver within an ear of a user.

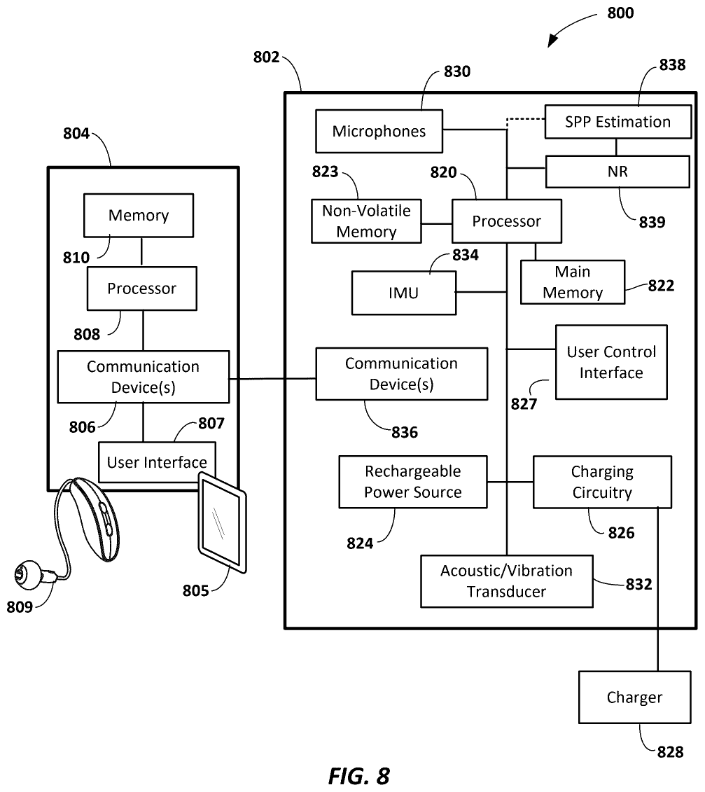

In FIG. 8, a block diagram illustrates a system and ear-wearable/hearing device 800 in accordance with any of the embodiments disclosed herein. The hearing device 800 includes a housing 802 configured to be worn in, on, or about an ear of a wearer. The hearing device 800 shown in FIG. 8 can represent a single hearing device configured for monaural or single-ear operation or one of a pair of hearing devices configured for binaural or dual-ear operation. Where two devices are used, they may be functionally equivalent, e.g., perform the same operations as least as it relates to DOA processing. Functionally equivalent devices may still operate differently, e.g., having different physical form for left/right sides, having different ear canal fittings, having different sound processing settings to deal with ear-specific (left or right) pathologies, etc.

The hearing device 800 shown in FIG. 8 includes a housing 802 within or on which various components are situated or supported. The housing 802 can be configured for deployment on a wearer's ear (e.g., a behind-the-ear device housing), within an ear canal of the wearer's ear (e.g., an in-the-ear, in-the-canal, invisible-in-canal, or completely-in-the-canal device housing) or both on and in a wearer's ear (e.g., a receiver-in-canal or receiver-in-the-ear device housing).

The hearing device 800 includes a processor 820 operatively coupled to a main memory 822 and a non-volatile memory 823. The processor 820 can be implemented as one or more of a multi-core processor, a digital signal processor (DSP), a microprocessor, a programmable controller, a general-purpose computer, a special-purpose computer, a hardware controller, a software controller, a combined hardware and software device, such as a programmable logic controller, and a programmable logic device (e.g., FPGA, ASIC). The processor 820 can include or be operatively coupled to main memory 822, such as RAM (e.g., DRAM, SRAM). The processor 820 can include or be operatively coupled to non-volatile (persistent) memory 823, such as ROM, EPROM, EEPROM or flash memory. As will be described in detail hereinbelow, the non-volatile memory 823 is configured to store instructions (e.g., in module 838) that enhance speech perception through management of a noise reduction module 839 as described elsewhere herein.

The hearing device 800 includes an audio processing facility (also referred to as an audio processor circuit) operably coupled to, or incorporating, the processor 820. The audio processing facility includes audio signal processing circuitry (e.g., analog front-end, analog-to-digital converter, digital-to-analog converter, DSP, and various analog and digital filters), a microphone arrangement 830, and an acoustic/vibration transducer 832 (e.g., loudspeaker, receiver, bone conduction transducer, motor actuator). The microphone arrangement 830 can include two or more discrete microphones or a microphone array(s) (e.g., configured for microphone array beamforming). Each of the microphones of the microphone arrangement 830 can be situated at different locations of the housing 802. It is understood that the term microphone used herein can refer to a single microphone or multiple microphones unless specified otherwise.

The acoustic transducer 832 produces amplified sound inside of the ear canal. For purposes of this disclosure, “amplified” sound refers to electronically reproduced sound, which typically involves the use of an amplifier to drive the acoustic transducer 832. Amplified sound does not necessarily imply an increase in sound pressure level of ambient sounds relative to what would be experienced with the device removed. In some cases, the amplified sound may result in an overall sound pressure level similar to ambient, e.g., where an equalization curve is applied to affect a small frequency range. In other cases, amplified sound can reduce the sound pressure level in the ear, e.g., via active noise cancellation.

The hearing device 800 may also include a user control interface 827 operatively coupled to the processor 820. The user control interface 827 is configured to receive an input from the wearer of the hearing device 800. The input from the wearer can be any type of user input, such as a touch input, a gesture input, and/or a voice input. The user control interface 827 may be configured to receive an input from the wearer of the hearing device 800.

The hearing device 800 also includes an SPP estimation module 838 operably coupled to the processor 820. The module 838 can be implemented in software, hardware (e.g., specialized neural network logic circuitry, general purpose processor), or a combination of hardware and software. During operation of the hearing device 800, the module 838 can be used to analyze audio signals generated from the microphone arrangement 830 and generate an estimate of SPP. These estimations are used by the NR module 839 and may be used by various other operational modules operable on the processor such as directionality and echo cancellation (not shown).

The hearing device may include other sensors, such as an IMU 834 to determine an operating context of the hearing device 800, e.g., in-ear, out-of-ear, etc., which can affect how the sound is analyzed and processed. The IMU 834 can also be used to assist in the SPP estimation 838, such as determining low frequency noise via accelerometers, detecting system disturbances, etc.

The hearing device 800 can include one or more communication devices 836. For example, the one or more communication devices 836 can include one or more radios coupled to one or more antenna arrangements that conform to an IEEE 802.8 (e.g., Wi-Fi®) or Bluetooth® (e.g., BLE, Bluetooth® 4.2, 5.0, 5.1, 5.2 or later) specification, for example. In addition, or alternatively, the hearing device 800 can include a near-field magnetic induction (NFMI) sensor (e.g., an NFMI transceiver coupled to a magnetic antenna) for effecting short-range communications (e.g., ear-to-ear communications, ear-to-kiosk communications). The communications device 836 may also include wired communications, e.g., universal serial bus (USB) and the like.

The communication device 836 is operable to allow the hearing device 800 to communicate with an external computing device 804, e.g., a mobile device 805 such as smartphone, laptop computer, table, etc. The external computing device 804 may also include a device usable by a clinician in a clinical setting, such as a desktop computer, test apparatus, etc. The external computing device 804 may also include a second hearing device 809, e.g. part of a pair of corresponding devices for both ears of the user.

The external computing device 804 includes a communications device 806 that is compatible with the communications device 836 for point-to-point or network communications. The external computing device 804 includes its own processor 808 and memory 810, the latter which may encompass both volatile and non-volatile memory. A user interface 807 facilitates interactions between the external computing device 804 and the hearing device 800, including access to settings that affect the SPP estimation module 838. The external computing device 804 may perform some functions described herein associated with the hearing device 800, such as SPP estimation using its own microphone (not shown) or via microphone 830 of the hearing device 800.

The hearing device 800 also includes a power source, which can be a conventional battery, a rechargeable battery (e.g., a lithium-ion battery), or a power source comprising a supercapacitor. In the embodiment shown in FIG. 8, the hearing device 800 includes a rechargeable power source 824 which is operably coupled to power management circuitry for supplying power to various components of the hearing device 800. The rechargeable power source 824 is coupled to charging circuitry 826. The charging circuitry 826 is electrically coupled to charging contacts on the housing 802 which are configured to electrically couple to corresponding charging contacts of a charger 828 when the hearing device 800 is placed in the charger.

In summary, the embodiments described above addresses challenges in noise reduction algorithms for hearing aids, focusing on passing high-quality information to the SMS and responding appropriately to changes in the acoustic environment. By integrating DNN assistance into the traditional NR approach, it introduces a proactive approach to mitigate undesirable noise artifacts and delivers users an optimized auditory experience across various acoustic scenarios.

This document discloses numerous example embodiments, including but not limited to the following:

Example 1 is an ear-wearable device, comprising: at least one microphone; a receiver that is placed within an ear of a user; an audio processing path that receives an audio signal from the at least one microphone and reproduces the audio signal at the receiver; a deep neural network (DNN) coupled to the audio processing path and trained to distinguish between speech and noise in the audio signal, a speech presence probability (SPP) of the audio signal being determined based on an output of the DNN; and a noise reduction system coupled to the audio processing path and operable to perform noise reduction on the audio signal, the noise reduction system being coupled to receive the SPP from the DNN and change an aggressiveness of the noise reduction based on a value of the SPP.

Example 2 includes the ear-wearable device of example 1, wherein the DNN comprises a recurrent neural network. Example 3 includes the ear-wearable device of example 1, wherein the DNN comprises a transformer network. Example 4 includes the ear-wearable device of example 1, wherein the DNN comprises an encoder-decoder.

Example 5 includes the ear-wearable device of any previous example, wherein an output of the DNN is a signal-to-noise ratio driven mask (SDM), and wherein the SPP is estimated based on the SDM. Example 6 includes the ear-wearable device of example 5, wherein SDM outputs are weighted with a speech intelligibility weighting function. Example 7 includes the ear-wearable device of any previous example, wherein the DNN is trained to directly provide the SPP.

Example 8 includes the ear-wearable device of any previous example, wherein the at least microphone comprises two or more microphones, and wherein the DNN detects the SPP based on two or more components of the audio signal associated with the respective two or more microphones. Example 9 includes the ear-wearable device of any previous example, wherein the DNN is configurable based on any combination of individual hearing preferences and usage patterns. Example 10 includes the ear-wearable device of any previous example, wherein the audio processing path further comprises an audio enhancement function to compensate for a hearing impairment of the user.

Example 11 is a processor-implemented method, comprising: receiving an audio signal from at least one microphone of an ear-wearable device; inputting the audio signal to a deep neural network (DNN) that is trained to distinguish between speech and noise in the audio signal; determining a speech presence probability (SPP) metric based on an output of the DNN; changing a strength of noise reduction applied to the audio signal based on a value of the SPP; and reproducing the noise-reduced audio signal via a receiver within an ear of a user.

Example 12 includes the method of example 11, wherein the DNN comprises a recurrent neural network. Example 13 includes the method of example 11, wherein the DNN comprises a transformer network. Example 14 includes the method of example 11, wherein the DNN comprises an encoder-decoder. Example 15 includes the method of any previous method example, further comprising training the DNN to output a signal-to-noise ratio driven mask (SDM), and wherein determining the SPP comprises determining the SPP based on the SDM. Example 16 includes the method of example 15, wherein SDM outputs are weighted with a speech intelligibility weighting function and wherein determining the SPP comprises determining the SPP based on the weighted SDM outputs.

Example 17 includes the method of any previous method example, further comprising training the DNN to directly provide the SPP. Example 18 includes the method of any previous method example, wherein the at least microphone comprises two or more microphones, and wherein the DNN detects the SPP based on two or more components of the audio signal associated with the respective two or more microphones. Example 19 includes the method of any previous method example, further comprising configuring the DNN based on any combination of individual hearing preferences and usage patterns. Example 20 includes the method of any previous method example, further comprising applying an audio enhancement function to the audio signal to compensate for a hearing impairment of the user.

Although reference is made herein to the accompanying set of drawings that form part of this disclosure, one of at least ordinary skill in the art will appreciate that various adaptations and modifications of the embodiments described herein are within, or do not depart from, the scope of this disclosure. For example, aspects of the embodiments described herein may be combined in a variety of ways with each other. Therefore, it is to be understood that, within the scope of the appended claims, the claimed invention may be practiced other than as explicitly described herein.

All references and publications cited herein are expressly incorporated herein by reference in their entirety into this disclosure, except to the extent they may directly contradict this disclosure. Unless otherwise indicated, all numbers expressing feature sizes, amounts, and physical properties used in the specification may be understood as being modified either by the term “exactly” or “about.” Accordingly, unless indicated to the contrary, the numerical parameters set forth in the foregoing specification are approximations that can vary depending upon the desired properties sought to be obtained by those skilled in the art utilizing the teachings disclosed herein or, for example, within typical ranges of experimental error.

The recitation of numerical ranges by endpoints includes all numbers subsumed within that range (e.g., 1 to 5 includes 1, 1.5, 2, 2.75, 3, 3.80, 4, and 5) and any range within that range. Herein, the terms “up to” or “no greater than” a number (e.g., up to 50) includes the number (e.g., 50), and the term “no less than” a number (e.g., no less than 5) includes the number (e.g., 5).

The terms “coupled” or “connected” refer to elements being attached to each other either directly (in direct contact with each other) or indirectly (having one or more elements between and attaching the two elements). Either term may be modified by “operatively” and “operably,” which may be used interchangeably, to describe that the coupling or connection is configured to allow the components to interact to carry out at least some functionality (for example, a radio chip may be operably coupled to an antenna element to provide a radio frequency electric signal for wireless communication).

Terms related to orientation, such as “top,” “bottom,” “side,” and “end,” are used to describe relative positions of components and are not meant to limit the orientation of the embodiments contemplated. For example, an embodiment described as having a “top” and “bottom” also encompasses embodiments thereof rotated in various directions unless the content clearly dictates otherwise.

Reference to “one embodiment,” “an embodiment,” “certain embodiments,” or “some embodiments,” etc., means that a particular feature, configuration, composition, or characteristic described in connection with the embodiment is included in at least one embodiment of the disclosure. Thus, the appearances of such phrases in various places throughout are not necessarily referring to the same embodiment of the disclosure. Furthermore, the particular features, configurations, compositions, or characteristics may be combined in any suitable manner in one or more embodiments.

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the disclosure.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

As used herein, “have,” “having,” “include,” “including,” “comprise,” “comprising” or the like are used in their open-ended sense, and generally mean “including, but not limited to.” It will be understood that “consisting essentially of,” “consisting of,” and the like are subsumed in “comprising,” and the like. The term “and/or” means one or all of the listed elements or a combination of at least two of the listed elements.

The phrases “at least one of,” “comprises at least one of,” and “one or more of” followed by a list refers to any one of the items in the list and any combination of two or more items in the list.

1. An ear-wearable device, comprising:
at least one microphone;
a receiver that is placed within an ear of a user;
an audio processing path that receives an audio signal from the at least one microphone and reproduces the audio signal at the receiver;
a deep neural network (DNN) coupled to the audio processing path and trained to distinguish between speech and noise in the audio signal, a speech presence probability (SPP) of the audio signal being determined based on an output of the DNN; and
a noise reduction system coupled to the audio processing path and operable to perform noise reduction on the audio signal, the noise reduction system being coupled to receive the SPP from the DNN and change an aggressiveness of the noise reduction based on a value of the SPP.

2. The ear-wearable device of claim 1, wherein the DNN comprises at least one of a recurrent neural network, a transformer network, and an encoder-decoder.

3. The ear-wearable device of claim 1, wherein an output of the DNN is a signal-to-noise ratio driven mask (SDM) that applies weighting to a noisy-speech signal in order to separate the speech from the noise, and wherein the SPP is estimated based on the SDM.

4. The ear-wearable device of claim 3, wherein the SDM is weighted with a speech intelligibility weighting function.

5. The ear-wearable device of claim 4, wherein the SDM weighting is time varying to boost time-frequency blocks where the speech is dominant and attenuate the time-frequency blocks where the speech is not present.

6. The ear-wearable device of claim 1, wherein the DNN is trained to directly provide the SPP.

7. The ear-wearable device of claim 1, wherein the at least microphone comprises two or more microphones, and wherein the DNN detects the SPP based on two or more components of the audio signal associated with the respective two or more microphones.

8. The ear-wearable device of claim 1, wherein the DNN is configurable based on any combination of individual hearing preferences and usage patterns.

9. The ear-wearable device of claim 1, wherein the audio processing path further comprises an audio enhancement function to compensate for a hearing impairment of the user.

10. A processor-implemented method, comprising:
receiving an audio signal from at least one microphone of an ear-wearable device;
inputting the audio signal to a deep neural network (DNN) that is trained to distinguish between speech and noise in the audio signal;
determining a speech presence probability (SPP) metric based on an output of the DNN;
changing a strength of noise reduction applied to the audio signal based on a value of the SPP; and
reproducing the noise-reduced audio signal via a receiver within an ear of a user.

11. The method of claim 10, wherein the DNN comprises at least one of a recurrent neural network, a transformer network, and an encoder-decoder.

12. The method of claim 10, further comprising training the DNN to output a signal-to-noise ratio driven mask (SDM) that applies weighting to a noisy-speech signal in order to separate the speech from the noise, and wherein determining the SPP comprises determining the SPP based on the SDM.

13. The method of claim 12, wherein SDM outputs are weighted with a speech intelligibility weighting function and wherein determining the SPP comprises determining the SPP based on the weighted SDM outputs.

14. The method of claim 13, wherein the SDM weighting is time-varying to boost time-frequency blocks where the speech is dominant and attenuate the time-frequency blocks where the speech is not present.

15. The method of claim 10, further comprising training the DNN to directly provide the SPP.

16. The method of claim 10, wherein the at least microphone comprises two or more microphones, and wherein the DNN detects the SPP based on two or more components of the audio signal associated with the respective two or more microphones.

17. The method of claim 10, further comprising configuring the DNN based on any combination of individual hearing preferences and usage patterns.

18. The method of claim 10, further comprising applying an audio enhancement function to the audio signal to compensate for a hearing impairment of the user.
